(19) United States
(12) Patent Application Publication
(10) Pub. No.: US 2011/0163927 A1
(43) Pub. Date: Jul. 7, 2011

(54) AMPLIFIED ANTENNA HAVING SMART ANTENNA INTERFACE

(76) Inventor: KEVIN SU, Irvine, CA (US)

(21) Appl. No.: 12/683,438

(22) Filed: Jan. 7, 2010

(51) Int. Cl. H01Q 1/00; H01Q 1/50; H04N 7/173

(52) U.S. Cl. 343/720; 343/905; 343/906; 725/132

(57) ABSTRACT

An amplified antenna includes an antenna element configured to receive over-the-air television broadcast signals and an amplification circuit for amplifying those received signals. The amplified signal is transmitted via an RF output terminal through an RF cable to a second device that is compatible with smart antenna technology as prescribed by the EIC-909 standard, Antenna Control Interface. The amplified antenna further includes an EIC-909 type jack, into which one end of a modular connector cable conforming to the EIC-909 standard is connected. The opposite end of the modular connector cable is connected to the EIC-909 interface jack of the second device. The amplified antenna can then draw electrical power from the smart antenna control module of the second device through the modular connector cable to drive the amplification circuit.

### FIELD OF THE INVENTION

The present invention is in the field of antennas. More particularly, the invention is in the field of antennas for over-the-air television broadcasts.

### BACKGROUND OF THE INVENTION

By act of Congress, television stations in the United States broadcasting over-the-air signals were required to switch off their analog channels and begin broadcasting exclusively in digital format in the summer of 2009. The switchover to digital broadcasting provided various benefits, including improved television picture quality and additional bandwidth being freed for other purposes. One unfortunate consequence of the switchover to digital broadcasting is that legacy television sets having only the capability to receive and display analog signals were no longer able to receive over-the-air broadcasts.

In order to accommodate the segment of the public that wanted to continue using analog televisions, the US government instituted a program subsidizing consumer purchase of digital-to-analog converter devices. A converter device, or “converter box”, is designed to receive digital broadcast signals, convert the signals to analog, and transfer the converted signals to an analog television set for display. Under the subsidy program, consumer electronic manufacturers were encouraged to develop converter boxes in accordance with guidelines promulgated by the FCC. Consumers who purchased converter boxes that met FCC guidelines in terms of performance and features received a rebate from the federal government to offset the purchase cost.

One feature sometimes included on converter boxes is smart antenna compatibility. In this application, the concept of smart antenna technology refers to the standard promulgated by the Electronics Industry Alliance (“EIA”) and defined by EIA-909 standard “Antenna Control Interface”, which is incorporated herein by reference, along with any revisions thereto. Generally speaking, a smart antenna either physically rotates toward a desired signal, or is stationary but has elements pointed in different directions where only those elements pointed toward the signal are “active” or utilized. According to EIA-909, the antenna array of a smart antenna is divided into sixteen segments, and the selection of which segments to use is accomplished by feedback from a control device, such as a smart antenna control module of a smart antenna compatible converter box that can communicate to the smart antenna which segments provide the strongest reception.

FIG. 1 is a schematic block diagram of one typical prior art implementation of a smart antenna in conjunction with a suitably-configured converter box (i.e., a converter box having smart antenna compatibility). As shown, smart antenna 100 comprises antenna array 110, which is ordinarily divided into sixteen segments. Smart antenna 100 is connected to converter box 150 via RF cable 120 and modular connector cable 130. Smart antenna 100 is configured to receive television broadcast signals and to transfer the signals to converter box 150.

Converter box 150 includes smart antenna control module 170 which is enabled to communicate with, and control certain operations of, smart antenna 100 via modular connector cable 130. Communication between the two devices can be unidirectional, with information sent from smart antenna control module 170 to smart antenna 100, or bidirectional, where information is sent back and forth between the two. The primary purpose of the communication is for smart antenna control module 170 to provide information and instructions to smart antenna 100 regarding which direction yields the best, i.e., strongest, signal. Based on the information received from smart antenna control module 170, antenna array 110 of smart antenna 100 can be tuned accordingly for enhanced reception. Broadcast signals received by smart antenna 100 are transmitted to converter box 150 via RF cable 120. In the illustrated arrangement, the broadcast signals are then converted to an analog signal by D/A converter 160 and outputted for display on a non-digital television set.

According to EIA-909, connector cable 120 comprises six pins (or lines), through which communication between converter box 150 and smart antenna 100 occurs. One such instance of communication occurs at initial setup when smart antenna 100 and smart antenna control module 170 engage in a handshaking protocol that permits smart antenna control module 170 to recognize that a smart antenna device has been connected.

Also according to EIA-909, smart antenna 100 is driven by electrical power from the coupled device (in this example, converter box 150) through one of the six pins (or lines) of modular connector cable 130. It is therefore not necessary, according to this implementation, for smart antenna 100 to have an alternative power source in order to function.

One drawback of smart antennas is that they are generally more expensive than traditional antennas, such as the simple “rabbit ear”, bow tie, or set top type antennas consumers often place on top of, and connect to, their television sets. These simple antennas, however, are seldom able to provide smart antenna-quality reception. Also, they may require frequent manual adjustment and tuning in order to achieve adequate signal reception—an inconvenience consumers would rather avoid.

An alternative to the simple antenna types and smart antennas is a class of antennas sometimes referred to as “amplified antennas”. These antennas are typically fixed and not manually tunable or adjustable; however, rather than operating passively like the simpler antenna types, amplified antennas include circuitry to amplify received television signals, thereby enhancing reception quality. As such, users do not have to manually tune or adjust the antenna to achieve improved reception—that task is accomplished by the amplified antenna itself. Amplified antennas do not conform to the requirements of EIA-909 and, for example, do not include a segmentalized antenna array.

FIG. 2 illustrates an implementation of a prior art amplified antenna operating with a converter box having smart antenna compatibility. As shown, amplified antenna 200 includes antenna element 210 and amplification circuit 240. In this implementation, broadcast signals are received by antenna element 210 and sent to amplification circuit 240 to be amplified. The process and technique of signal amplification are known in the art. The amplified signal is then transmitted to converter box 250 via RF cable 220. D/A converter 260 converts the signals from amplified antenna 200 to an analog signal suitable for display by a non-digital television. Note that there is no functional or physical connection between amplified antenna 200 and smart antenna control module 270 in this arrangement, even though converter box 250 includes smart antenna control module 270 and is, therefore, compatible with smart antenna technology.

Further, unlike the simple rabbit ear and bowtie antennas, amplified antennas require a power supply to drive the amplification circuitry. As illustrated in FIG. 2, electrical power can be provided to amplified antenna 200 via power cord 230 when plugged into a suitable electric outlet.

As noted above, amplified antennas include circuitry for amplifying received television signals, and the amplification circuits require electrical power to function. With prior art amplified antennas, such power must be drawn from an electric outlet through a standard electrical power cord. As a result, the consumer must devote at least one socket solely to power such prior art amplified antennas. Further, the need to connect to an outlet via an electrical power cord can create unsightly and unwanted clutter.

As such, there is a need in the art for an amplified antenna that does not need to draw AC power from an electric outlet via an electrical power cord.

### SUMMARY OF THE INVENTION

The present invention is directed to an amplified antenna having smart antenna interface. The invention overcomes shortcomings associated with amplified antennas having amplification circuits that require AC, or electrical, power through an electrical power cord plugged into a suitable electric outlet.

In one embodiment of the invention, an amplified antenna includes an antenna element configured to receive over-the-air television broadcast signals and an amplification circuit for amplifying those received signals, resulting in a stronger signal. The amplified signal is transmitted via an RF output terminal through an RF cable to a second device, where that second device is compatible with smart antenna technology as prescribed by the EIC-909 standard, Antenna Control Interface. The amplified antenna further includes an EIC-909 type jack, into which one end of a modular connector cable conforming to the EIC-909 standard is connected. The opposite end of the modular connector cable is connected to the EIC-909 interface jack of the second device. The amplified antenna can then draw electrical power from the smart antenna control module of the second device through the modular connector cable to drive the amplification circuit.

In one embodiment of the invention, the amplified antenna is connected to a converter box that is compatible with smart antenna technology.

In one embodiment of the invention, the amplified antenna is connected to a digital television that is compatible with smart antenna technology.

### BRIEF DESCRIPTION OF THE DRAWINGS

FIG. 1 illustrates a prior art implementation of a smart antenna.

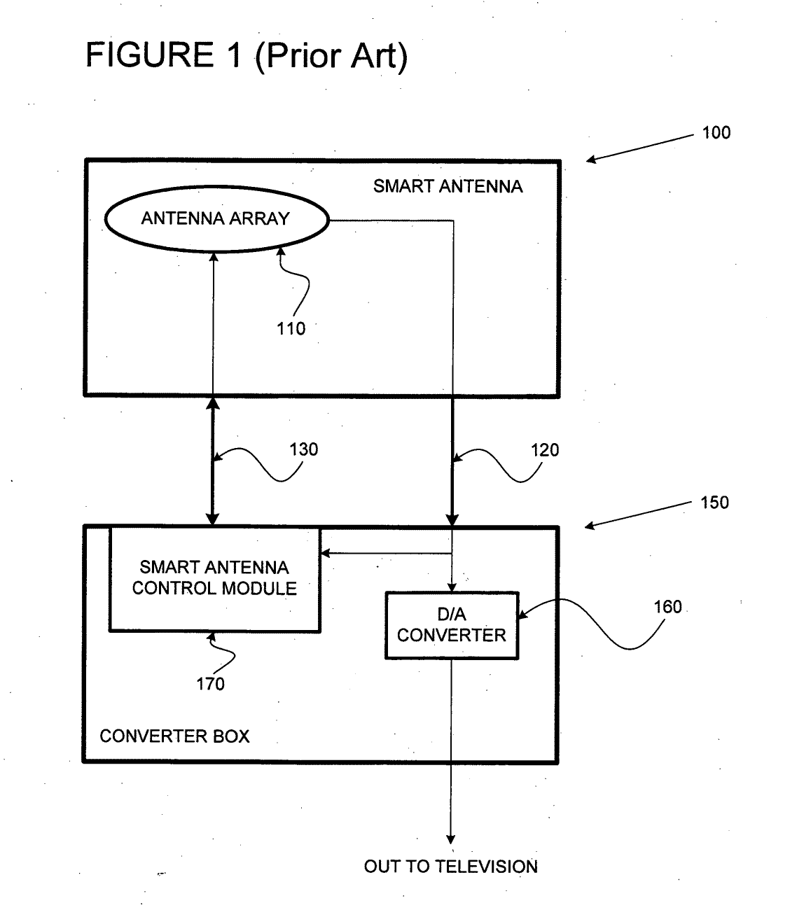

FIG. 2 illustrates a prior art implementation of an amplified antenna.

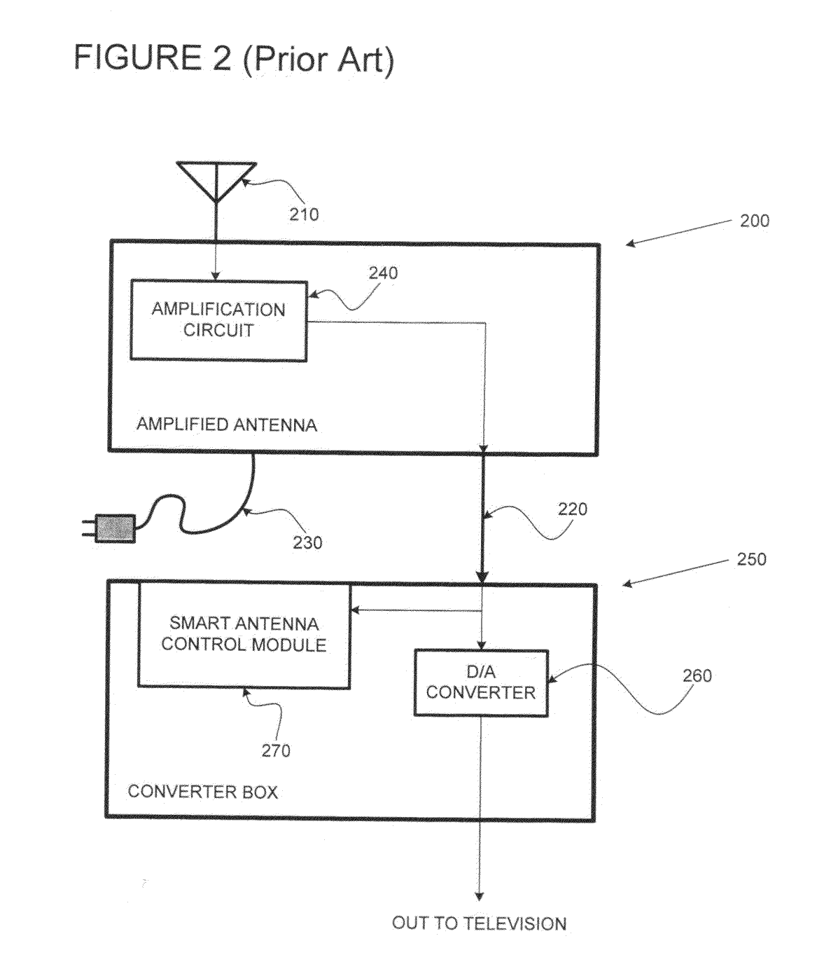

FIG. 3 illustrates a block diagram of an amplified antenna in accordance with one embodiment of the invention.

FIG. 4 illustrates an implementation of an amplified antenna in accordance with one embodiment of the invention.

FIG. 5 illustrates an implementation of an amplified antenna in accordance with one embodiment of the invention.

### DETAILED DESCRIPTION OF THE INVENTION

The present invention is directed to amplified antenna having smart antenna interface. The following description contains specific information pertaining to various embodiments and implementations of the invention. One skilled in the art will recognize that the present invention may be practiced in a manner different from that specifically discussed in the present application. Moreover, some of the specific details of the invention are not discussed in order not to obscure the invention. The specific details not described in the present application are within knowledge of a person of ordinary skill in the art.

The drawing in the present application and their accompanying detailed description are directed to merely exemplify embodiments of the invention. To maintain brevity, other embodiments of the invention that use the principles of the present invention are not specifically described in the present application and are not illustrated by the present drawings.

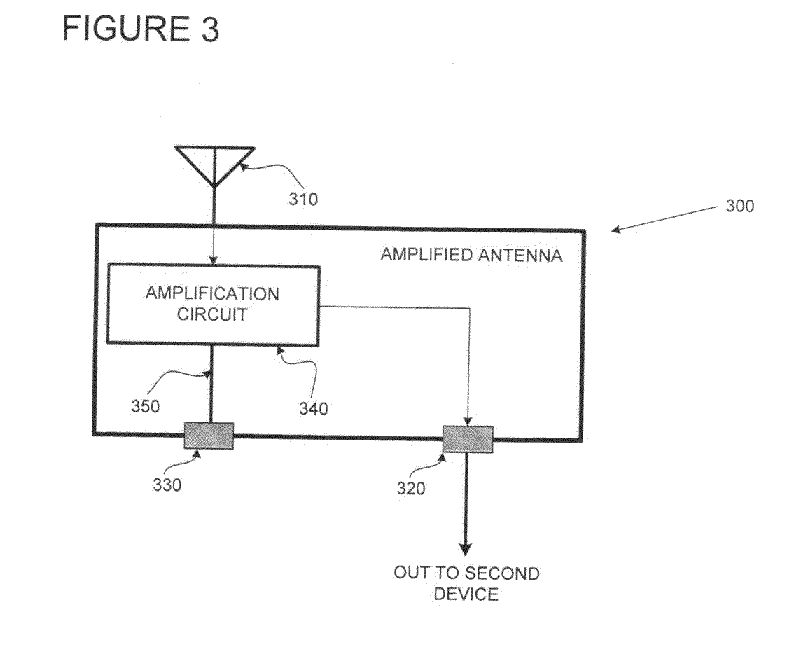

FIG. 3 illustrates the claimed antenna device in accordance with one embodiment of the invention. Amplified antenna 300 includes antenna element 310, which is functionally connected to amplification circuit 340. As shown, power line 350 connects amplification circuit 340 to EIA-909 type jack 330. Amplification circuit 340 is also connected to RF output terminal 320. Even thought amplified antenna 300 has an EIA-909 type jack, it is expressly not a smart antenna and does not conform to the requirements of the EIA-909 standard, “Antenna Control Interface”. For example, amplified antenna 300 does not include an antenna array divided into sixteen segments as prescribed by the EIA-909 standard.

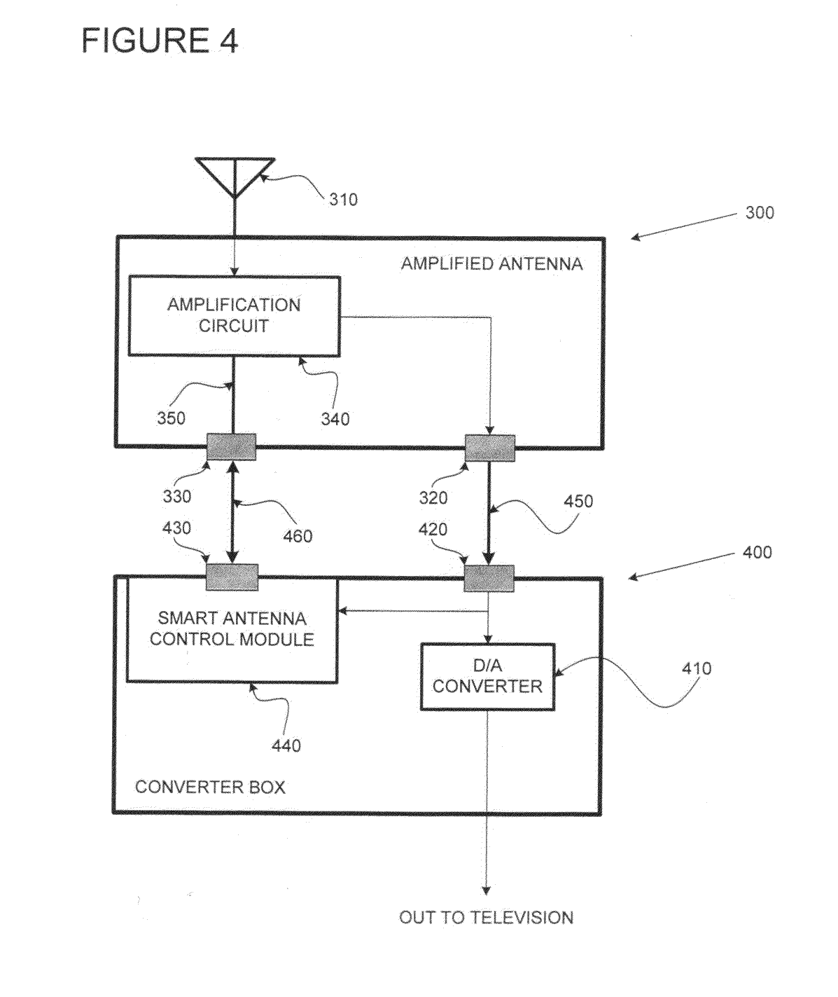

FIG. 4 illustrates an implementation of amplified antenna 300 in accordance with one embodiment of the invention. Amplified antenna 300 is connected to converter box 400, which comprises RF input terminal 420, D/A (i.e., digital-to-analog) converter 410, and smart antenna control module 440. In this example, it is noted that smart antenna control module 440 of converter box 400 conforms to EIA-909, is configured to operate compatibly with smart antennas that also conform to EIA-909, and includes an EIA-909 interface jack 430 for interfacing with smart antennas. In other words, converter box 400 is a prior art converter box configured to work with smart antennas.

As shown in FIG. 4, amplified antenna 300 is connected to converter box 400 via RF cable 450. Antenna element 310 of amplified antenna 300 is configured to receive over-the-air television broadcast signals. The received signals are then amplified by amplification circuit 340 in a manner known in the art, resulting in a stronger signal that is outputted at RF output terminal 320 to converter box 400 at RF input terminal 420 via RF cable 450. In converter box 400, the signals received from amplified antenna 300 are transmitted to D/A converter 410 for conversion to an analog signal, suitable for reception and display by non-digital televisions.

Further, amplified antenna 300 is also connected to converter box 400 via modular connector cable 460. A first end of modular connector cable 460 is connected to EIA-909 type jack 330 of amplified antenna 300 and a second end is connected to EIA-909 interface jack 430 of smart antenna control module 440 of converter box 400. Modular connector cable 460 is a 6-pin (or line) type cable defined by the EIA-909 standard.

In this embodiment, amplified antenna 300 is configured to engage in a handshaking protocol with smart antenna module 440 when the physical connection is made between amplified antenna 300 and smart antenna control module 440 via modular connector cable 460. During the handshake, which comprises transmitting an electrical signal mimicking a signal sent by a true smart antenna, amplified antenna 300 falsely represents to smart antenna module 440 that a connection has been made to a smart antenna, rather than an amplified antenna. By virtue of this handshake, amplified antenna 300 is able to deceive smart antenna module 440 into operating as if it were actually connected to a smart antenna. Once smart antenna control module 440 is in this mode where it operates as if connected to a smart antenna, amplified antenna 300 can draw electrical power from smart antenna control module 440 via modular connector cable 460 and power line 350 to drive amplification circuit 340. Thus, amplified antenna 300 makes advantageous use of an available power supply from smart antenna module 440 of converter box 400, rather than requiring an alternate power source. For example, amplified antenna 300 does not need to be plugged into an electric outlet of power.

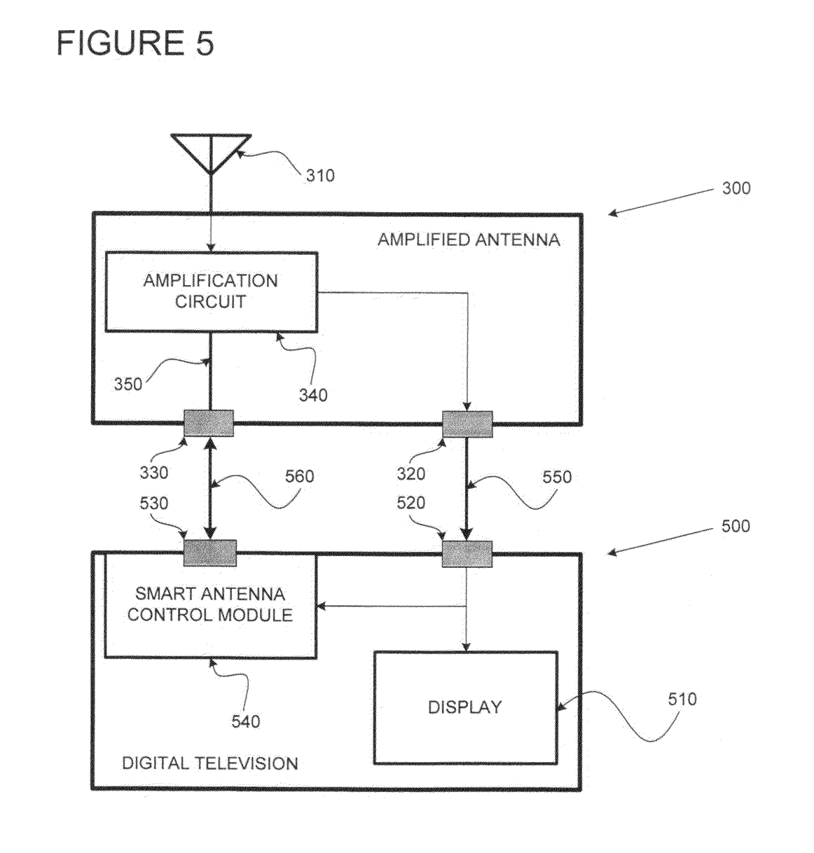

FIG. 5 illustrates an implementation of amplified antenna 300 in accordance with another embodiment of the invention. As shown, amplified antenna 300 is connected to digital television 500, which comprises smart antenna module 540, RF input terminal 520, and display 510.

Amplified antenna 300 comprises antenna element 310, amplification circuit 340, and RF output terminal 320. As discussed above, antenna element 310 is configured to receive over-the-air television broadcast signals, which are then amplified by amplification circuit 340 to increase the strength and enhance the quality of the received broadcast signals. The amplified broadcast signals are then transmitted from RF output terminal 320 through RF cable 550 to RF input terminal 520 of digital television 500 for display on display 510.

As further illustrated in FIG. 5, amplified antenna 300 is also connected to smart antenna control module 540 of digital television 500 via modular connector cable 560. Smart antenna control module 540 conforms to the EIA-909 Smart Interface Connector standard, is configured to operate compatibly with a smart antenna that also conforms to EIA-909, and includes EIA-909 interface jack 530 for interfacing with a smart antenna. A first end of modular connector cable 560 is connected to EIA-909 type jack 330 of amplified antenna 300 and a second end is connected to the EIA-909 interface jack 530 of smart antenna control module 540 of digital television 500. Modular connector cable 560 is a 6-pin (or line) type connector cable defined by the EIA-909 standard. Consistent with the requirements of the EIA-909 standard, smart antenna control module 540 is configured to provide electrical power through one of the six leads, or lines, of modular connector cable 560.

EIA-909 type jack 330 is configured to draw electrical power from smart antenna control module 540 through modular connector cable 560. The power can then flow through power cable 350 to drive amplification circuit 340. In this manner, amplified antenna 300 takes advantage of the available power from smart antenna control module 540 to power amplification circuit 340.

The invention has been described with specific reference to certain embodiments. However, persons of skill in the art would recognize that changes can be made in form and detail without departing from the spirit of the scope of the invention. The described embodiments are to be considered in all respects as illustrative and not restrictive. It should also be understood that the invention is not limited to the particular embodiments described herein, but is capable of many rearrangements, modifications, and substitutions without departing from the scope of the invention.

Thus, amplified antenna having smart antenna interface has been described.

What I claim is:

1. An amplified antenna comprising:
an antenna element configured to receive over-the-air television broadcast signals;
an amplification circuit configured to amplify said received signals; and
an EIC-909 type interface jack configured to operatively connect to a smart antenna control module of a second device via a modular connector cable;
wherein said amplified antenna draws power from said smart antenna control module through said modular connector cable to drive said amplification circuit.

2. The amplified antenna of claim 1 where in said second device is a converter box.

3. The amplified antenna of claim 1 wherein said second device is a digital television.

4. The amplified antenna of claim 1 further comprising an RF output terminal for outputting said received signals to said second device.

5. The amplified antenna of claim 1 further comprising a power cord for drawing power from a suitable electric outlet.

6. An amplified antenna not conforming to EIC-909 Smart Interface Connector standard, said amplified antenna comprising:
an antenna element configured to receive over-the-air television broadcast signals;
an amplification circuit configured to amplify said signals; and
an EIC-909 type interface jack configured to operatively couple to a smart antenna control module of a second device via a modular connector cable and to draw power from said second device through said modular connector cable to drive said amplification circuit.

7. The amplified antenna of claim 6 where in said second device is a converter box.

8. The amplified antenna of claim 6 wherein said second device is a digital television.

9. The amplified antenna of claim 6 further comprising an RF output terminal for outputting said received signals to said second device.

10. An amplified antenna comprising:
an antenna element for receiving over-the-air television broadcast signals;
an amplification circuit for amplifying said signals; and
an interface jack conforming to EIC-909 standard for connecting to a smart antenna control module of a second device via a modular connector cable;
wherein electrical power flows from said smart antenna control module of said second device through said modular connector cable to said amplified antenna; and
wherein said electrical power is utilized to drive said amplification circuit.

11. The amplified antenna of claim 10 where in said second device is a converter box.

12. The amplified antenna of claim 10 wherein said second device is a digital television.

13. The amplified antenna of claim 10 further comprising an RF output terminal for outputting said received signals to said second device.

14. An amplified antenna not conforming to EIC-909 Smart Interface Connector standard, said amplified antenna comprising:
means for receiving over-the-air television broadcast signals;
means for amplifying said signals; and
means for connecting to a smart antenna control module of a second device and drawing electrical power from said second device.

15. The amplified antenna of claim 14 where in said second device is a converter box.

16. The amplified antenna of claim 14 wherein said second device is a digital television.

17. The amplified antenna of claim 14 further comprising means for outputting said amplified signals to said second device.
